(19) United States
(12) Patent Application Publication
(10) Pub. No.: US 2016/0016516 A1
(43) Pub. Date: Jan. 21, 2016

(54) Mounting Device for Fixing an Imaging Device of an Indirect Vision System to a Vehicle

(71) Applicant: Mekra Lang GmbH & Co. KG, Ergersheim (DE)

(72) Inventors: Werner Lang, Ergersheim (DE); Georg Hecht, Weihenzell (DE); Matthias Zink, Ohrenbach (DE); Orhan Kilic, Ansbach (DE)

(21) Appl. No.: 14/803,072

(22) Filed: Jul. 18, 2015

(30) Foreign Application Priority Data
Jul. 21, 2014 (DE) 102014214128.1

(51) Int. Cl. B60R 1/00; B60R 11/04

(52) U.S. Cl. CPC B60R 1/00; B60R 11/04

(57) ABSTRACT

A mounting device for an indirect vision system of a vehicle includes a support arm attached to the vehicle, an imaging device such as a mirror glass and a carrier member onto which the imaging device is mounted. The carrier member includes thermoplastic melt-processable material that is molded around a fixing area of the support arm such that the thermoplastic material completely seals and circumferentially surrounds the fixing area of the support arm. Except in the fixing area, the cross section of the support arm is circular. For example, in the fixing area the support arm is oval or kidney shaped or has a groove into which the thermoplastic material enters as the material is molded around the fixing area. In the fixing area, the support arm has various gripping surfaces or protruding pins or bolts that improve the axial positional fixing of the carrier member to the support arm.

### CROSS REFERENCE TO RELATED APPLICATION

This application is based on and hereby claims the benefit under 35 U.S.C.§119 from German Patent Application No. DE 102014214128.1, filed on Jul. 21, 2014, in the German Patent Office. This application is a continuation-in-part of German Patent Application No. DE 102014214128.1, the contents of which are incorporated herein by reference.

### TECHNICAL FIELD

The invention relates to a mirror carrier for fixing an imaging device of an indirect vision system to a vehicle, particularly for a commercial vehicle. In addition, the present invention relates to such an indirect vision system that is equipped or furnished with a similar type of novel mirror carrier.

### BACKGROUND

A well-known example of an “imaging device of an indirect imaging system” is the mirror glass or reflective surface in an (exterior) rear view mirror of a vehicle. Other examples of such imaging devices are cameras and other image sensors. The following description, drawings and explained embodiments relate to the design of an imaging device in the form of a mirror glass or similar reflective area. The present invention is also equally applicable to other imaging devices such as cameras and the like. In general, the present invention and the mounting of its parts or components can be used on a carrier arm for direct or indirect driver support.

A rear-view mirror, in particular an exterior mirror and the associated mirror housing must be supported by and fixed to the vehicle or to the body parts of the vehicle. In these cases, the mirror is attached at a certain distance from the body part so that the rear view mirror can be used for its designed purpose. It is standard practice to use cantilevered support arms or support brackets that are normally secured to the vehicle body at one end and carry the mirror housing on the other free end. In the case of support brackets, the bracket is equipped with two support arms that are both connected at one end to the vehicle body, and the two other free ends are jointly connected by an additional support arm. The usually nearly vertically extending support arm is then used to attach one or more rear view mirrors and their mirror housings.

Irrespective of the design of the support arm that is fixed to the vehicle, the connection between the support arm and the imaging system (or the mirror housing or mirror carrier) is a critical aspect of the entire rear-view-mirror or indirect-vision system. Increased attention must be devoted so that the requirements that occur in practice are fulfilled, and therefore that the manufacturing, assembly and maintenance of the indirect-vision or rear-view-mirror systems do not create any possible disadvantages.

The device for mounting and aligning the rear view mirror on a vehicle is collectively referred to herein as a carrier device, mirror carrier or mounting device. The support arm is fastened to the vehicle, and at least one end is attachable to the arm support member. The support member in turn has connection means for mounting in the same way as the rear view mirror or the mirror housing. The support member is important because it is fastened to the bracket and thus represents the interface between the mirror and the support arm.

The connection between the support member and support arm must be able to be installed with little effort. The entire indirect-vision or rear-view-mirror system must not add too much bulk and must be vibration-resistant, durable and secured long-term, i.e., resistant to loosening. It is standard practice to fix the support member to the support arm by cable clamps or comparable clamping devices. The problem here is that the clamp connection loosens over time due to vibrations, thermally-induced expansion and contraction processes, driving wind pressure or other similar factors. Attention must also be paid to the aspect of corrosion, so that unsuitable material combinations must be avoided.

Other mounting configurations for the support member to the support arm are screws or pins. These connecting options also suffer from the disadvantages of susceptibility to vibration, risk of loosening and, in most instances, insufficient continuous load resistance due to material fatigue and fractures or the like.

Thus, a mounting or support device is sought that can be manufactured with a minimum of design and construction effort and has maximum operational reliability and functionality that is sustainable over a long service lifetime.

### SUMMARY

A mirror carrier for attaching an imaging device of an indirect vision system to a vehicle includes a support arm fixed to the vehicle and at least one carrier member attached to the support arm. The carrier member uses contact points to mount the imaging device. The carrier member is formed, at least on a fixing area of the support arm, from a thermoplastic melt-processable material and encapsulates the support arm as a closed-walled thermoplastic mold. The carrier member is molded around the support arm in the fixing area of the support arm using an injection molding process.

A mounting device for an indirect vision system of a vehicle includes a support arm attached to the vehicle, an imaging device such as a mirror glass and a carrier member onto which the imaging device is mounted. The carrier member includes thermoplastic melt-processable material that is injection molded around a fixing area of the support arm such that the thermoplastic material completely seals and circumferentially surrounds the fixing area of the support arm. In the fixing area, the support arm has various gripping surfaces or protruding pins or bolts that improve the axial positional fixing of the carrier member to the support arm. Except in the fixing area, the cross section of the support arm is circular. For example, in the fixing area the support arm is oval or kidney shaped or has a groove into which the thermoplastic material enters as the material is molded around the fixing area. In one embodiment, the thermoplastic material shrinks away from portions of the fixing area as the thermoplastic material cures so as to exert pressure along a longitudinal groove in the support arm to create a gripping tension between the carrier member and the support arm. In another embodiment, the thermoplastic material circumferentially surrounds the fixing area of the support arm in multiple separate ring-shaped gripping sections.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention. The separate figures are schematic and not necessarily drawn in corresponding scale to one another.

FIG. 1 is a schematic cross-sectional view of a glass adjuster with a mirror carrier in accordance with an embodiment of the invention.

FIG. 2 shows a simplified view of a mirror carrier of an indirect-vision system, which is a glass-adjusting, rear-view-mirror unit.

FIG. 3 is an adaptation of the device of FIG. 2 in which the indirect-vision system is a head-adjusting rear view mirror unit.

FIG. 4 is a schematic cross-sectional view of a head adjuster with a mirror carrier in accordance with another embodiment.

FIG. 5 shows yet another embodiment of a head adjuster with a mirror carrier.

FIG. 6 is a cross-sectional view of a mirror carrier with an adapter.

FIG. 7 is a cross-sectional view of a mirror carrier with interchangeable members.

FIG. 8 is a cross-sectional view of a further embodiment of a glass adjuster in which the longitudinal axis of the support arm and the longitudinal axis of the mirror are offset from one another.

FIG. 9 shows four different designs of a support arm surface in the fixing area of the carrier member.

FIG. 10 is a cross-sectional view illustrating the result of targeted form-tensioning caused by shrinkage in the fixing area of the carrier member.

FIG. 11 shows a side view of one possible design of the carrier member in its fixing area.

FIG. 12 shows a side view of another design of the carrier member in its fixing area.

FIG. 13 is a schematic cross-sectional view through a glass adjuster with a mirror carrier in accordance with another embodiment similar to that of FIG. 1.

FIG. 14 shows a variation of the embodiment of FIG. 13.

### DETAILED DESCRIPTION

Reference will now be made in detail to some embodiments of the invention, examples of which are illustrated in the accompanying drawings.

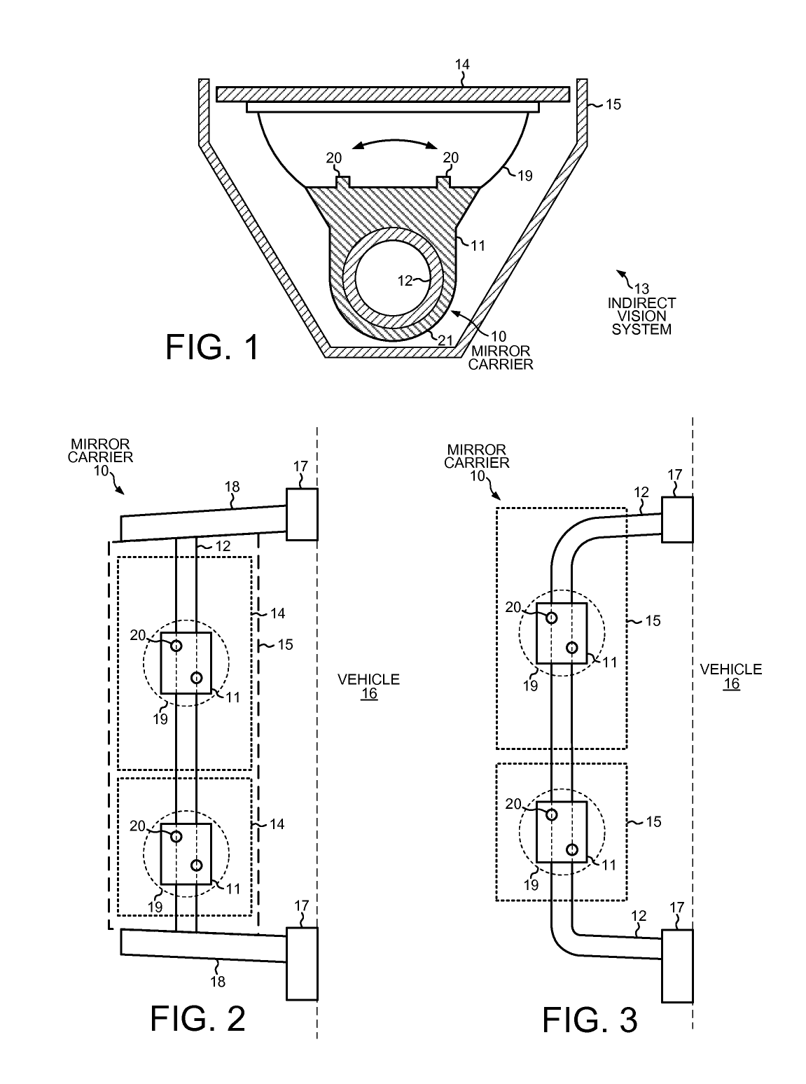

FIG. 1 shows a mounting device or mirror carrier 10 of an indirect vision system that includes a novel carrier member 11 constructed from a thermoplast, melt-processed material molded in a fixing area around a support arm 12. The carrier member 11 and its fixing area surround the support arm 12 at least in a section as a closed-wall unit.

The carrier member 11 is thermoplastically molded to the support arm 12 instead of being attached by mechanical, auxiliary or additional materials, such as screws, bolts, clamps or other similar methods. Thus, the carrier member 11 surrounds the carrying arm as a closed-walled unit. The term “closed-walled” signifies that the carrier member 11 completely seals and surrounds the support arm 12 circumferentially without any interruptions. The molding to form a closed wall is in contrast to a slotted clamp in the axial direction of the terminal, which is then clamped to the support arm 12 by a clamping screw, bolt or the like.

The mounting and securing of the carrier member 11 is thus achieved solely by thermoplastic shaping of the carrier member 11, at least in its fixing area, so that complex mechanical clamping and fixing methods and any associated problems and disadvantages can be dispensed with. Because the carrier member 11, at least within the fixing area, is shaped around the support arm 12 as a closed-wall system due to its thermoplastic form, the fixing of the carrier member 11 on the support arm 12 is extremely stable, vibration-resistant and durable.

The support arm 12 is formed as an elongated, rectilinear unit, at least in the fixing area, with the carrier member 11, as is already customary in bow-shaped carrier devices. However, the novel carrier member 11 is equally applicable to simply designed support arms in which the indirect vision system 13 (mirror, mirror head, mirror housings) is fastened on the free end of a single arm.

The support arm 12 has a tubular profile, which is available as a prefabricated and inexpensive, semi-finished product. The thermoplastic shaping of the carrier member 11, at least in the fixing area around the support arm 12, allows the carrier member 11 to be fixed directly and in close contact with the periphery of the support arm 12, even when there are deviations from the target shape requirement or the target contour shape in the fixing area. For example, if the support arm 12 in the fixing area includes deviations in its dimensions due to previous prefabrication or processing steps, such as deformations from bending operations, surface irregularities, etc., it is not necessary to realign the support arm 12 again to create the target contour or the target surface cross-section so that a clamp connection can satisfactorily function. The carrier member 11 “forges” itself virtually gap-free by utilizing thermoplastic forming and is therefore also secure for such deformed support arms. The tubular profile preferably has a round cross-section and is therefore inexpensive and simple to obtain and to produce.

To increase the secure connection between the carrier member 11 and the support arm 12, the support arm 12 has a different shape in the fixing area from the rest of the tubular profile that has a round cross section. The different cross section can be formed by a targeted, permanent deformation of the tubular section wall by lateral flattening to provide the support arm 12 in the fastening area with a more or less pronounced oval cross-section. The tube can also have other cross-sectional profiles, such as a rounded cross-section with a flat section or with edges formed by a pressing process.

The different cross sections improve the connection between the carrier member 11 and the support arm 12 in the circumferential direction, and therefore also better protect against any twisting of the carrier member 11 in relation to the support arm 12. In order to improve the axial positional fixing of the carrier member 11 to the support arm 12, the divergent shape can be formed with a separate component that is rigidly connected around the profile of the tube and projects outwards from it. These projecting components can be pins, bolts or screws that are inserted or screwed into the support arm 12 and that protrude radially from the tube's external circumference. The protruding components both protect against twisting as well as against displacement of the attached carrier member 11.

Other possibilities for increasing the connection strength are grooves, creases, drill holes, indentations and knurls on the outer peripheral surface in the fixing area between the carrier member 11 and the support arm 12. These surface deformations also improve the connection and interlocking between the support arm 12 and the thermoplastically formed material of the carrier member 11.

In one embodiment, the carrier member 11 is cast around the support arm 12 in the fixing area using injection molding. The casting of the carrier member 11 around the support arm 12 in a plasticized state of the thermoplastic material enables in a single process step not only the formation of the carrier member 11 itself, but also the attachment to the support arm 12. The support arm 12 is essentially molded into the fixing area of the carrier member 11 in a distortion-free process. The molding ensures that there are no inherent tensions in the produced carrier member 11 that could lead, particularly at low temperatures, to breakages of the carrier member 11 when it is exposed to shocks or impacts.

However, there can also be a radially directed shrinkage in the fixing area after the casting process that leads to a directed and wanted tensioning between the support arm 12 and the carrier member 11. The support arm 12 can still exhibit surface contouring that presses against sections of the shrunk, tensioned carrier member 11. This shrinkage and tensioning ensures that the connection between the support arm 12 and the carrier member 11 is particularly secure.

The imaging device may be a rear view mirror, in which case the carrier member 11 is part of a glass adjuster. The carrier member 11 can also be part of a head adjuster. The support arm 12 should be constructed of metal or a metal alloy with the appropriate strength and resistance values.

Along with the carrier member 11 for an imaging device, an additional component may be arranged on the support arm 12 that functions to support or assist the driver. One such additional component is the transmitter or receiver for a GPS system. The additional component is also fixed to a carrier member 11 on the support arm 12. The subject matter of the present invention is not limited to imaging devices, but instead covers a general attachment method for construction members and components on support arms that support and assist the driver of the vehicle.

FIG. 1 shows an embodiment of an imaging device of an indirect vision system 13 that is attached to a vehicle by the novel carrier member 11. The imaging device has a mirror carrier 10 (a mounting device) and a rear-view-mirror portion. The mirror carrier 10 holds a mirror glass 14 located in a mirror housing 15. Besides mirror glass 14, other embodiments of imaging devices have other reflective surfaces, cameras or other sensors instead of the mirror glass 14. In other embodiments, mirror carrier 10 is a mounting device for the other reflective surface, camera or sensor.

The fixing of the mirror carrier 10 (or mounting device) onto the vehicle 16 is performed using the support arms 12 shown in FIGS. 2 and 3. The support arms 12 are attached to the vehicle 16 at the connection points 17 of the mirror carrier 10. FIGS. 2 and 3 illustrate two different designs for both the mirror carrier 10 as well as for the complete system. FIG. 2 shows a glass adjuster in which the angle or orientation of the mirror glass 14 is adjusted independently of the housing 15. FIG. 3 shows a head adjuster in which the orientation of the mirror glass 14 and the housing 15 are adjusted together. Because the mirror housing 15 is fixedly connected to the mirror glass 14, the mirror glass and mirror housing always have the same orientation. The mirror carrier 10 of FIG. 2 has two cantilevers 18 protruding from both connection points 17. A support arm 12 passes through both cantilevers 18 and is preferably designed as a metal tube with a circular cross-section.

In the embodiment of FIG. 2, two carrier members 11 are attached to the support arm 12 between the cantilevers 18. Each of the carrier members 11 carries an adjustment unit 19. Each carrier member 11 is attached to an adjustment unit 19 at contact points 20. Each adjustment unit 19 carries a mirror glass 14. The entire arrangement of support arm 12, carrier members 11, adjustment units 19 and mirror glasses 14 is located in the mirror housing 15. The mirror housing 15 is fixed in its position, and the individual mirror glasses 14 can be moved independently of each other by using the respective adjustment units 19.

The embodiment of FIG. 3 does not have a separate support arm that passes between two cantilevers as illustrated in FIG. 2. Instead, the mirror carrier 10 of FIG. 3 has a continuous U-shaped bent bow 12. Both of the shanks of bent bow 12 are attached at their free ends to the vehicle body at the connection points 17. An essentially straight section of the bent bow 12 passes between both shanks and has the functionality of the separate support arm 12 of FIG. 2. The straight section can be used to attach the carrier members 11. Each carrier member 11 and the associated mirror housing 15 can be arranged in the desired orientation of the mirror glass 14 located in the mirror housing 15. Thus, the mirror glass 14 is adjusted by moving the associated mirror housing 15.

The latest technical standards determine the exact construction of the embodiments of FIGS. 2 and 3 and the dimensions and locations of the connection points 17, the cantilevers 18, the support arm 12, the carrier members 11, the adjusting units 19 and the contact points 20. The present invention focuses on the attachment and securing of the carrier members 11 to the support arm 12 or straight section of the bent bow 12. The prior art uses various types of clamping, bolting or screwing techniques to fix the carrier members to the support arm. The subject matter of the present invention discloses how the carrier member 11 is formed, at least in the fixing section of the support arm 12, from a thermoplastic melt-processed material such as a plastic or synthetic resin. The thermoplastic molding of the carrier member 11 enables the carrier member to be a closed-wall circumferential member surrounding the support arm 12, at least over a partial section of the support arm 12 in the fixing area.

FIG. 1 illustrates the basic design of the present invention in a cross-sectional representation. The carrier member 11 is formed from a thermoplastic melt-processed or cast thermoplastic material and grips or molds around the support arm 12 in a fixing area in a closed-wall manner. By “closed-wall” is to be understood within the framework of the present invention that a gripping section 21 of the carrier member 11 grips the support arm 12 as shown in FIG. 1, without any space between the two. Thus, gripping section 21 of carrier member 11 is not cut open to install around support arm 12. The only openings in gripping section 21 are cuts with a minimum size required to accommodate one or more positioning and/or fixing means (bolts, screws) in order to clamp the carrier member 11 securely to support arm 12.

FIG. 1 illustrates a design of a mirror carrier 10 that uses a glass adjuster method, which means that the mirror glass 14 is held in place by the adjusting unit 19, and the adjusting unit 19 is connected to the carrier member 11 by the contact points 20. Thus, the orientation of the mirror glass 14 can be adjusted independently from that of the mirror housing 15. The double arrow in FIG. 1 illustrates the movement that the adjustment unit 19 can impart on the mirror glass 14. The mirror housing 15 is thereby static and fixed to both cantilevers 18 as shown in FIG. 2.

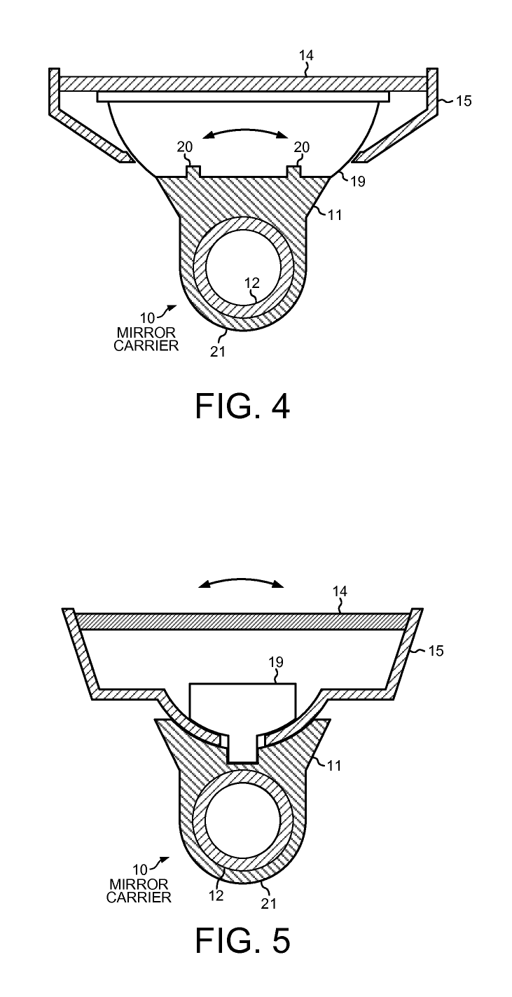

FIG. 4 illustrates a design of a mirror carrier 10 that uses a head adjuster method, which means that the adjusting member 19 moves the mirror housing 15 together with the mirror glass 14. In this case, the carrier member 11 is also, at least in the fixing area of the support arm 12, thermoplastically molded around and grips the support arm 12 in its gripping section 21.

FIG. 5 also illustrates a design using a head adjuster method in which, contrary to FIG. 4, the adjusting unit 19 does not directly support the mirror glass 14. Rather, adjusting unit 19 moves the mirror housing 15, which in turn holds the mirror glass 14. In this design, the carrier member 11 is also thermoplastically molded around and grips the support arm 12. The gripping section 21 of the support arm 12 grips the fixing area of the support arm 12 in a closed-wall manner.

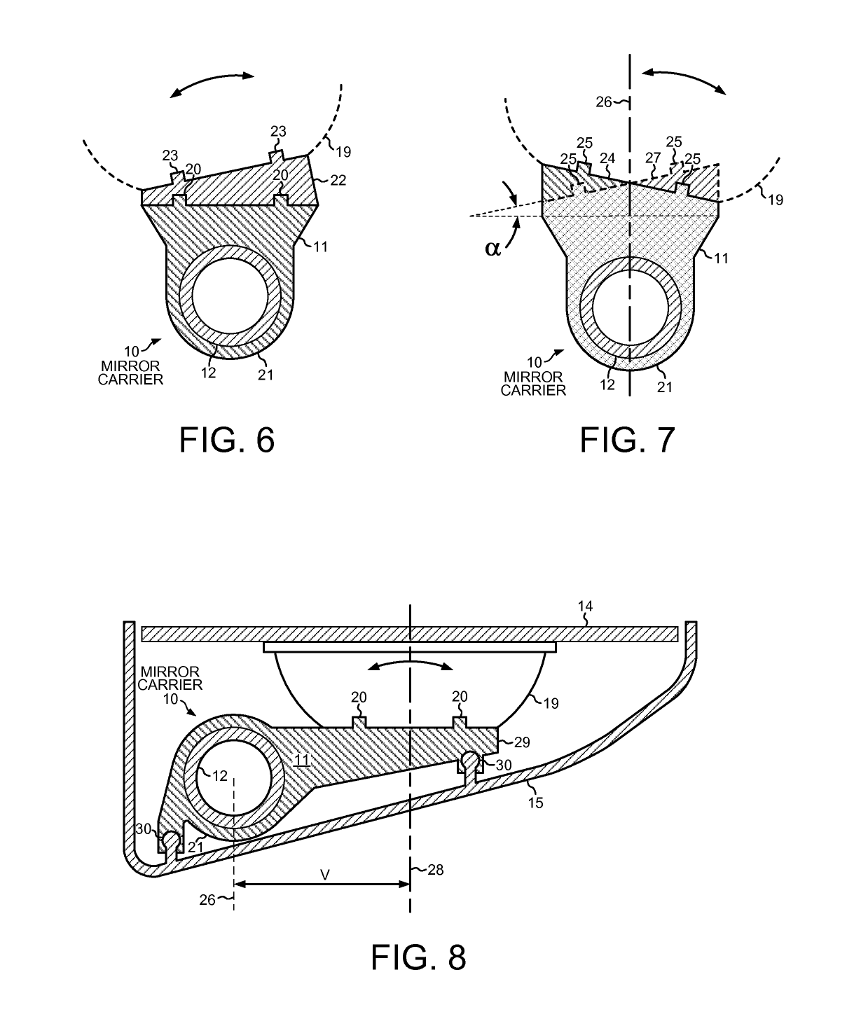

FIG. 6 illustrates a modification of carrier member 11 in which an adapter 22 is attached to the contact points 20 of the carrier member 11 so that in the zero position of the adjusting member 19, the mirror glass 14 and the mirror housing 15 are already slightly angled. The adapter 22 is fitted with supplemental contact points 23 analogous to the contact points 20 on the side of the carrier member.

FIG. 7 illustrates a modification to carrier member 11 similar to that of FIG. 6 except that the carrier member itself has an angled contact surface 24, and no adapter is used. The modified carrier member 11 has contact points 25 on its angled contact surface 24 that are centered on either side of the longitudinal axis 26 of modified carrier member 11. The contact surface 24 is already tilted to a defined angle a from the original horizontal contact surface of the carrier member 11 of FIG. 6. The modified carrier member 11 can be formed such that the tilt is either to the right (contact surface 24) or to the left (contact surface 27) as shown in FIG. 7. The size of the angle α is dependent on the required installation position of the mirror glasses or mirror housings.

FIG. 8 shows an embodiment of a mirror carrier 10 in which the centered longitudinal axis 28 through mirror glass 14 is offset by an offset V from a longitudinal axis 26 through the central of support arm 12. The carrier member 11 has a cantilever 29 that supports the contact points 20 and that extends radially outwards from the support arm 12. FIG. 8 also shows the fixing points 30 at which the cantilever 29 and the carrier member 11 are attached to the mirror housing 15. Because the mirror glass 14 is adjusted without moving the mirror housing 15, the design of this embodiment uses a glass adjuster method. The fixing points 30 are optionally releasably connected to the carrier member 11. The carrier member 11 is connected in the fixing area to the support arm 12 in a closed-wall manner. Various features can be formed to increase the holding force between the carrier member 11 and the support arm 12 in the fixing area. These features create an anti-twist protection on their own, only a safeguard against axial displacement, or a combination thereof.

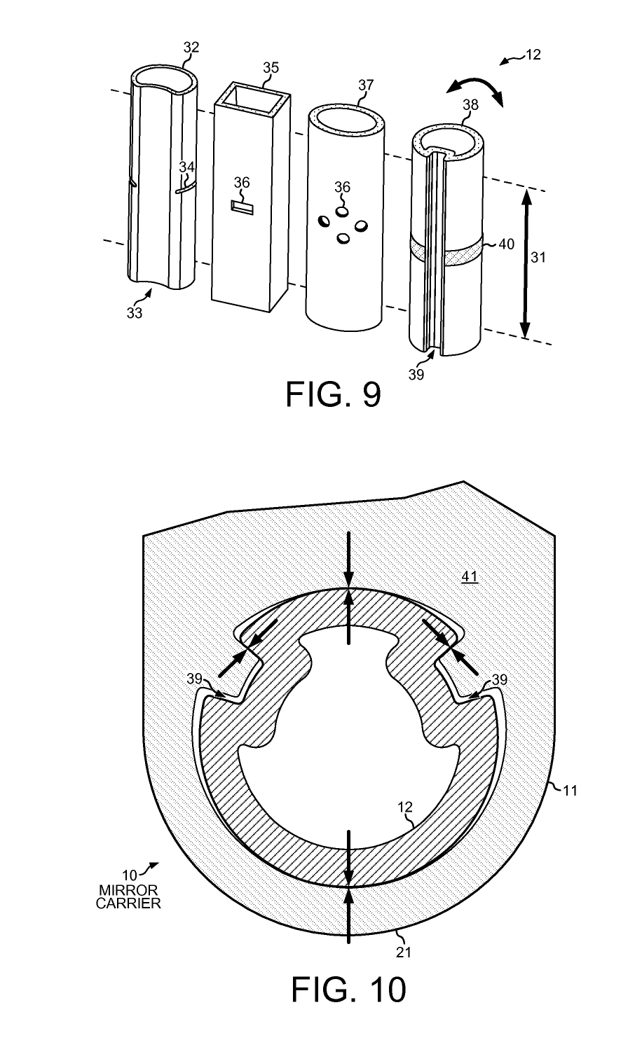

FIG. 9 shows four different possible shapes for the support arm 12. To improve the axial positional fixing of the carrier member 11 to the support arm 12, none of the cross sections of the support arm in the various designs of FIG. 9 is circular. In addition, FIG. 9 shows various gripping surfaces in the fixing areas 31 of the support arms 12. At least in the fixing area 31 of the embodiment 32 on the left in FIG. 9, the horizontal cross section of the support arm 12 is kidney shaped and is compressed from the circular cross section of FIG. 1 by a longitudinal indentation 33 that indents one side of the circular cross section. The indentation 33 imparts an increased torsional strength to the support arm 12 and to the carrier member 11 molded around the support arm 12. In addition to the indentation 33, the support arm 12 can have one or more horizontal grooves 34 in the fixing area into which the material of the gripping section 21 of the carrier member 11 can enter when the carrier member 11 is formed by molding. In another aspect, the support arm 12 is indented from both sides and has a second indentation opposite indentation 33.

The embodiment 35 at the second-to-left position in FIG. 9 has a polygonal cross section, such as a square shape. Due to this polygonal or multi-cornered cross section, the carrier member 11 is prevented from rotating about the support arm 12. Openings or drill holes 36 can be formed in one or multiple walls of the multi-surfaces support arm 12. Screws, bolts, pins or molded thermoplastic material can enter these holes and secure the carrier member 11 to the support arm 12 in both the radial direction and the axial direction. The thermoplastic material of the gripping section 21 of the carrier member 11 can enter the small openings 36 or grooves when the carrier member 11 is molded around the fixing area 31 to improve the bonding between the carrier member 11 and the support arm 12.

The third design 37 from the left in FIG. 9 illustrates the support arm 12 with an oval cross section that improves the attachment of the carrier member 11 to the support arm 12 in the radial direction. In addition, one or more openings 36 are provided in the peripheral wall of the support arm 12 to improve the grip of the molded material of the carrier member 11 to the fixing area 31 of the support arm 12. Separate components such as screws, bolts or pins may project out of the openings 36 in the tubular wall of the support arm 12 so as to improve the bonding of the thermoplastic material to the fixing area 31 as the material molds around the protruding components.

The design 38 on the far right in FIG. 9 illustrates the support arm 12 with a longitudinal groove 39 in the fixing area 31. The design 38 also has one or more circumferentially extending knurls or roughed grooves 40.

The carrier member 11 may be formed entirely from a thermoplastic melt-processable material or it may include the thermoplastic melt-processable material only in the gripping section 21. The thermoplastic material grips the outer circumference of the support arm 12 completely as a closed-wall system and thereby creates a tight unit. In addition, the features shown in FIG. 9 can be added to improve the radial and/or axial bonding of the carrier member 11 to the support arm 12.

One way in which to form the carrier member 11 as an enclosure on the support arm 12 is to cast the carrier member 11 around the support arm 12 in the fixing area 31 using injection molding. The support arm 12 is inserted into the mold before the injection molding process is performed. The molding process can hereby take place without tension such that, after curing of the thermoplastic melt-processable section of the carrier member 11, the thermoplastic material attaches essentially free of tension around the circumference of the support arm 12.

FIG. 10 is an expanded view of the carrier member 11 surrounding the support arm 12 and illustrates a modified manner in which the thermoplastic material 41 encases the support arm 12. The thermoplastic material 41 encloses the support arm 12 in a closed-wall manner in which the material is made to undergo targeted shrinkage that creates tensioning between the carrier member 11 and the external surfaces of the support arm 12. In order to achieve the tensioning, deformations in the circumference of the support arm 12 are formed such as the longitudinal grooves 39 of the design 38 on the far right in FIG. 9. During molding, the thermoplastic material 41 penetrates into the grooves 39. During curing of the thermoplastic material 41, a targeted deformation and shrinkage occurs in the material of the carrier member 11 in the gripping section 21. As shown in FIG. 10, the carrier member 11 holds the support arm 12 in tension preferably at a plurality of longitudinal grooves 39 at which surface pressure is exerted on the outside surface of the support arm 12. Thus, as the thermoplastic material cures it shrinks away from portions of the outer surface of the support arm 12 so as to exert pressure along sides of the longitudinal grooves 39 in a gripping tension between the carrier member 11 and the support arm 12.

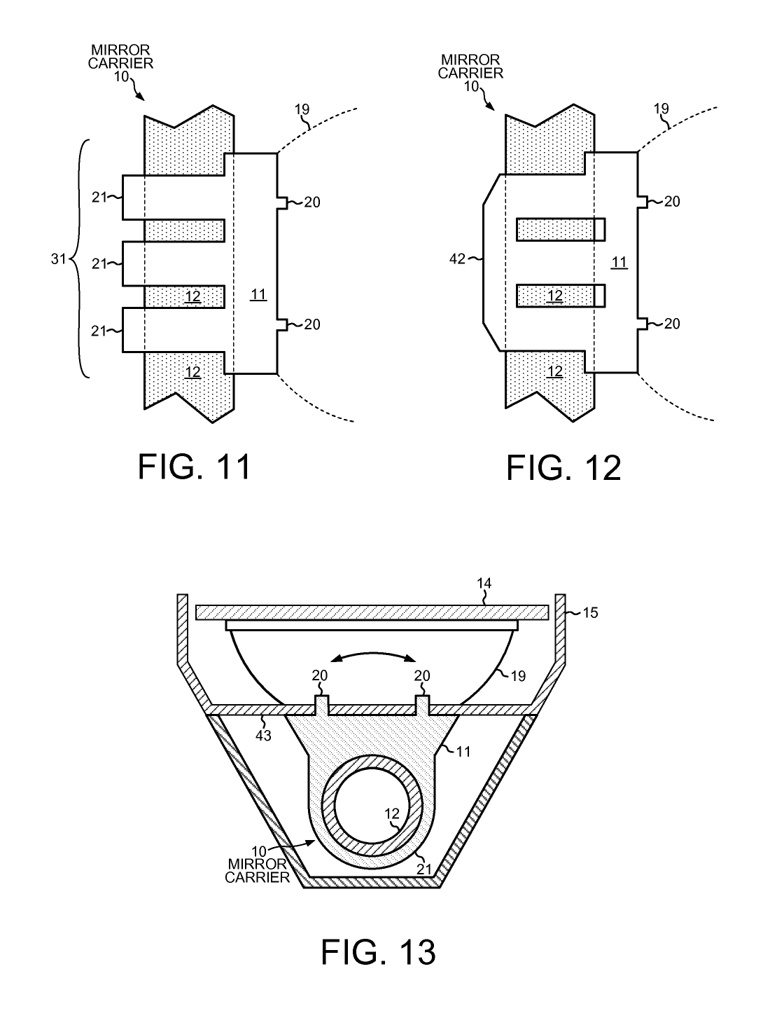

FIGS. 11 and 12 illustrate how several gripping sections 21 of the carrier member 11 can be formed that completely encase the support arm 12 in a closed-wall manner. A clearance or spacing exists between the separate gripping sections 21. Each separate gripping section 21 can be a cantilever-type projection from the carrier member 11, and each section 21 can grip and enclose the fixing area 31 of the support arm 12 as a ring. In the embodiment of FIG. 12, the free ends of each gripping section 21 are connected by a rib 42 to the other sections. Instead of the individually formed, ring-shaped gripping sections 21 of FIG. 11, the gripping sections 21, the rib 42 and the carrier member 11 of FIG. 12 together form a sleeve around the fixing area 31 of the support arm 12.

FIG. 13 shows another embodiment of a glass-adjuster mirror carrier 10 in which the orientation of the mirror glass 14 is adjusted independently of the mirror housing 15. The mirror housing 15 is supported by a rib or plate 43 on the carrier member 11 and is not attached to a cantilever 18 as in the embodiment of FIG. 2. The contact points 20 of the carrier member 11 pass through the plate 43.

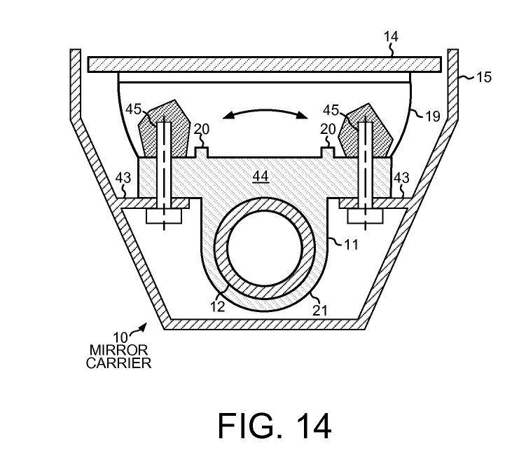

FIG. 14 shows yet another embodiment of a glass-adjuster mirror carrier 10 in which the adjustment unit 19 is connected to a base 44 of the carrier member 11. The contact points 20 are located on the base 44 under the adjustment unit 19. The base 44 of the carrier member 11 passes through an appropriately dimensioned opening in the plate 43 and is attached at the periphery of the opening by screws 45 or equivalent fasteners that pass through the plate 43. The screws 45 pass through the plate 43 from the side of the support arm 12 and they may terminate in the base 44 or, as shown in FIG. 14, they may continue into the adjustment unit 19. A unitary assembly component is formed from the mirror housing 15, the base 44 (and thus the carrier member 11) and the adjustment unit 19.

The carrier member 11 is formed in the fastening region of the support arm 12 by molding a thermoplastic melt-processable material 41 around the support arm. The carrier member 11 can also be formed from other materials, such as a casting metal or a thermosetting plastic, fiber or fabric-reinforced synthetic resin or the like. The use of a thermoplastic melt-processable material is particularly advantageous because when the carrier member 11 is formed entirely of a thermoplastic melt-processable material, the carrier member can be formed in the desired shape and can be attached to the support arm 12 in a single working operation, for example by injection molding. If the carrier member is a two- or multi-part construction, it may have a thermoplastic melt-processable section that is mounted on an already shaped carrier member. The thermoplastic material 41 is then molded by an appropriate processing method to cover the support arm 12 in a closed-wall manner at least over the fixing area 31. For example, the two-part carrier member 11 can be made of aluminum or a similar suitable material, and a thermoplastic synthetic material can be molded to the aluminum and around the fixing area 31 of the support arm 12.

The enclosing or encapsulating of the support arm 12 by a part of the carrier member material also offers, along other benefits, the advantage that any irregularities in the shape or surface of the support arm are rendered unproblematic to achieving a good connection between the carrier member and the support arm because such irregularities in the encapsulation of the support arm are balanced or compensated by the material of the carrier member.

The present invention thereby provides a mirror carrier 10 with a carrier member 11 that is connected to a support arm 12 using a simple, cost-effective, corrosion resistant, vibration-resistant and reliable connection alternative to existing methods. The mirror carrier 10 itself attaches the image-forming device of the indirect vision system 13 to the vehicle 16 using a support member 11 molded to a support arm 12 that is fixed to the vehicle 16. Connection methods are required to mount the imaging device to the carrier member. The carrier member is formed, at least in the fixing area of the support arm, from a thermoplastic melt-processable material that encapsulates the support arm in a closed-wall manner.

### LIST OF REFERENCE NUMERALS

10 mirror carrier

11 carrier member

12 support arm

13 indirect vision system

14 mirror glass

15 mirror housing

16 vehicle

17 connection point

18 cantilever

19 adjustment unit

20 contact point

21 gripping section

22 adapter

23 contact point on adapter

24 contact surface

25 contact point on angled surface

26 longitudinal axis of carrier

27 inclined contact surface

28 longitudinal axis through glass

29 cantilever

30 fixing point

31 fixing area

32 first embodiment of support arm

33 indentation

34 groove

35 second embodiment of support arm

36 opening

37 third embodiment of support arm

38 fourth embodiment of support arm

39 longitudinal groove

40 knurls or roughed grooves

41 thermoplastic material

42 rib

43 plate

44 base

45 screw

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-15. (canceled)

16. A mounting device for an indirect vision system of a vehicle, comprising:
a support arm attached to the vehicle;
an imaging device; and
a carrier member onto which the imaging device is mounted, wherein the carrier member includes thermoplastic material that is molded around a fixing area of the support arm such that the thermoplastic material completely seals and circumferentially surrounds the fixing area of the support arm.

17. The mounting device of claim 16, wherein the support arm has a circular cross section except in the fixing area, where the cross section of the support arm deviates from being circular.

18. The mounting device of claim 17, wherein the cross section of the support arm is kidney shaped in the fixing area.

19. The mounting device of claim 16, wherein the support arm has a groove in the fixing area into which the thermoplastic material enters as the thermoplastic material is molded around the fixing area.

20. The mounting device of claim 16, wherein the support arm has a longitudinal groove in the fixing area into which the thermoplastic material penetrates as the thermoplastic material is molded around the fixing area, and wherein the thermoplastic material shrinks away from portions of the fixing area as the thermoplastic material cures so as to exert pressure along the longitudinal groove in a gripping tension between the carrier member and the support arm.

21. The mounting device of claim 16, further comprising:
components that protrude out of openings in the fixing area of the support arm, wherein the thermoplastic material molds around the protruding components.

22. The mounting device of claim 16, wherein the thermoplastic material is injection molded around the fixing area of the support arm.

23. The mounting device of claim 16, wherein the imaging device is a mirror glass.

24. The mounting device of claim 16, wherein the support arm is made of metal.

25. The mounting device of claim 16, further comprising:
a mirror housing that is fixedly connected to the imaging device such that the mirror housing and the imaging device always have the same orientation.

26. The mounting device of claim 16, further comprising:
a mirror housing whose orientation can be adjusted independently from that of the imaging device.

27. The mounting device of claim 16, wherein the thermoplastic material circumferentially surrounds the fixing area of the support arm with a first ring-shaped gripping section and with a separate second ring-shaped gripping section.

28. A mirror carrier, comprising:
a support arm adapted to be attached to a vehicle;
a carrier member; and
a mirror glass attached to the carrier member, wherein the carrier member includes thermoplastic material that is molded around a fixing area of the support arm such that the thermoplastic material completely seals and circumferentially surrounds the fixing area of the support arm.

29. The mirror carrier of claim 28, wherein the support arm does not have a circular cross section in the fixing area.

30. The mirror carrier of claim 29, wherein the cross section of the support arm is kidney shaped in the fixing area.

31. The mirror carrier of claim 28, wherein the support arm has a groove in the fixing area into which the thermoplastic material enters as the thermoplastic material is molded around the fixing area.

32. The mirror carrier of claim 28, wherein the support arm has a longitudinal groove in the fixing area into which the thermoplastic material penetrates as the thermoplastic material is molded around the fixing area, and wherein the thermoplastic material shrinks away from portions of the fixing area as the thermoplastic material cures so as to exert pressure along the longitudinal groove in a gripping tension between the carrier member and the support arm.

33. The mirror carrier of claim 28, further comprising:
components that protrude out of openings in the fixing area of the support arm, wherein the thermoplastic material molds around the protruding components.

34. The mirror carrier of claim 28, wherein the thermoplastic material is injection molded around the fixing area of the support arm.

35. The mirror carrier of claim 28, wherein the thermoplastic material circumferentially surrounds the fixing area of the support arm with a first ring-shaped gripping section and with a separate second ring-shaped gripping section.
